(19) United States
(12) Patent Application Publication
(10) Pub. No.: US 2024/0255290 A1
(43) Pub. Date: Aug. 1, 2024

(54) Vehicle And Method Of Estimating Distance According To Change In Vehicle Position

(71) Applicants: Hyundai Motor Company, Seoul (KR); Kia Corporation, Seoul (KR)

(72) Inventor: Jaehong Lee, Siheung-Si (KR)

(21) Appl. No.: 18/369,911

(22) Filed: Sep. 19, 2023

(30) Foreign Application Priority Data
Jan. 27, 2023 (KR) 10-2023-0010992

(51) Int. Cl. G01C 21/30; B60W 10/18; B60W 10/20; B60W 60/00; G06T 7/70; G06V 10/25; G06V 10/30; G06V 20/56

(52) U.S. Cl. CPC G01C 21/30; B60W 10/18; B60W 10/20; B60W 60/001; G06T 7/70; G06V 10/25; G06V 10/30; G06V 20/56; B60W 2420/403; G06T 2207/30252

(57) ABSTRACT

A vehicle and a method of estimating a distance according to a change in vehicle position are provided. The vehicle may include: a camera mounted on the vehicle to obtain an image outside the vehicle; an inertial measurement unit (IMU) device; and a processor configured to estimate a vehicle position of the vehicle based on the image obtained from the camera, and adjust the estimated vehicle position based on a measurement of the IMU device.

### CROSS-REFERENCE TO RELATED APPLICATION

This application is based on and claims priority to Korean Patent Application No. 10-2023-0010992, filed on Jan. 27, 2023 in the Korean Intellectual Property Office, the disclosure of which is incorporated herein by reference.

### TECHNICAL FIELD

The disclosure relates to a vehicle and more specifically an apparatus and a method for estimating a distance according to a change in vehicle position.

### BACKGROUND

Distance estimation is an integral part of autonomous driving, and accuracy of distance estimation can affect the overall safety of the vehicle. In autonomous vehicles, distance estimation may be performed using cameras based on the images obtained from the cameras.

When driving over bumps, unpaved roads, and other obstacles, a vehicle position may suddenly change, causing a distance calculation different from an actual distance due to a camera shake.

### SUMMARY

An aspect of the disclosure provides a vehicle and a method of estimating a distance according to a change in vehicle position that may estimate a position of the vehicle in real time and correct inaccurate distance information obtained from an image due to the change in vehicle position.

An aspect of the disclosure also provides a vehicle and a method of estimating a distance according to a change in vehicle position that may accurately estimate a position of the vehicle using vehicle positions of two sensors of a camera and an inertial measurement unit (IMU).

Additional aspects of the disclosure will be set forth in part in the description which follows and, in part, will be obvious from the description, or may be learned by practice of the disclosure.

According to one or more example embodiments of the present disclosure, a vehicle may include: a camera mounted on the vehicle to obtain an image outside the vehicle; an inertial measurement unit (IMU) device; and a processor configured to estimate, based on the image obtained from the camera, a vehicle position of the vehicle to yield a first estimated vehicle position; adjust, based on a measurement of the IMU device, the first estimated vehicle position to yield a second estimated vehicle position; and cause, based on the at least one of the first estimated vehicle position or the second estimated vehicle position, the vehicle to adjust at least one of: acceleration, steering, or braking.

The processor may be further configured to: remove image noise from the image obtained from the camera; and designate a region of interest in the image.

The processor may be further configured to extract, from the region of interest, a feature point.

The image may include a previous frame and a current frame. The processor is further configured to: track a change in position of the feature point across the previous frame and the current frame; and perform matching of the feature point between the previous frame and the current frame.

The image may include a previous frame and a current frame. The processor may be further configured to: track a change in position of the feature point across the previous frame and the current frame; and based on a mismatch of the feature point between the previous frame and the current frame, remove the feature point.

The processor may be further configured to estimate an essential matrix using a geometric relationship, in a normalized image plane, of the feature point between the previous frame and the current frame.

The processor may be further configured to: estimate, based on the essential matrix, a rotation matrix and a transformation matrix. The processor may be configured to estimate the vehicle position of the vehicle by estimating the vehicle position further based on the rotation matrix and the transformation matrix.

The processor may be further configured to estimate the vehicle position of the vehicle as facing up or down by estimating a pitch value based on the rotation matrix.

The processor may be further configured to: compare, based on a threshold value, an average value of a difference between the first estimated vehicle position and the second estimated vehicle position; and determine, based on the comparison, whether at least one of the first estimated vehicle position or the second estimated vehicle position is inaccurate.

The image may include a previous frame and a current frame that are separated by a time interval. The processor may be further configured to: determine: a first vehicle position difference, between the current frame and the previous frame, as measured by the camera, and a second vehicle position difference, between the current frame and the previous frame, as measured by the IMU device; and, based on a comparison between the first vehicle position difference and the second vehicle position difference, determine that one of the first estimated vehicle position or the second estimated vehicle position is inaccurate.

The processor may be further configured to: based on a determination that the first estimated vehicle position is inaccurate, initialize the first estimated vehicle position with the second estimated vehicle position; and based on a determination that the second estimated vehicle position is inaccurate, initialize the second estimated vehicle position with the first estimated vehicle position.

The processor may be further configured to: adjust a point of a three-dimensional (3D) coordinate system of an actual ground area according to a difference between the first estimated vehicle position and the second estimated vehicle position; obtain a point of a camera coordinate system corresponding to the adjusted point of the 3D coordinate system of the actual ground area; and estimate, based on a two-dimensional (2D) coordinate system of a ground area in the image, the 3D coordinate system of the actual ground area by a perspective transform matrix.

The processor may be further configured to estimate, based on the estimated 3D coordinate system of the actual ground area, a distance to an actual object that corresponds to a position of an object in the image.

According to one or more example embodiments, a method may include: estimating, based on an image obtained via a camera, a position of a vehicle to yield a first estimated vehicle position; adjusting, based on a measurement by an inertial measurement unit (IMU) device, the first estimated vehicle position to yield a second estimated vehicle position; based on a determination that the first estimated vehicle position is different from the second estimated vehicle position, adjusting a point of a three-dimensional (3D) coordinate system of an actual ground area according to a difference between the first estimated vehicle position and the second estimated vehicle position; obtaining a point of a camera coordinate system corresponding to the adjusted point of the 3D coordinate system of the actual ground area; estimating, based on a two-dimensional (2D) coordinate system of a ground area in the image, the 3D coordinate system of the actual ground area; estimating, based on the estimated 3D coordinate system of the actual ground area, a distance to an actual object that corresponds to a position of an object in the image; and causing, based on the at least one of the first estimated vehicle position or the second estimated vehicle position, the vehicle to adjust at least one of: acceleration, steering, or braking.

The image may include a previous frame and a current frame. Estimating the position of the vehicle based on the image obtained via the camera may include: removing image noise from the image; designating a region of interest in the image; extracting, from the region of interest, a feature point; tracking a change in position of the feature point across the previous frame and the current frame; and performing matching of the feature point between the previous frame and the current frame.

The method may further include: filtering to remove a mismatched feature point that does not match between the previous frame and the current frame.

The method may further include: estimating an essential matrix using a geometric relationship, in a normalized image plane, of the feature point between the previous frame and the current frame; and estimating, based on the essential matrix, a rotation matrix and a transformation matrix. Estimating the position of the vehicle may include estimating the position of the vehicle further based on the rotation matrix and the transformation matrix.

Estimating the position of the vehicle may include estimating the position of the vehicle as facing up or down by estimating a pitch value based on the rotation matrix.

Adjusting the first estimated vehicle position may include: comparing, based on a threshold value, an average value of a difference between the first estimated vehicle position and the second estimated vehicle position; and determining, based on the comparison, whether at least one of the first estimated vehicle position or the second estimated vehicle position is inaccurate.

The image may include a previous frame and a current frame that are separated by a time interval. The method may further include: determining: a first vehicle position difference, between the current frame and the previous frame, as measured by the camera, and a second vehicle position difference, between the current frame and the previous frame, as measured by the IMU device; and, based on a comparison between the first vehicle position difference and the second vehicle position difference, determining that one of the first estimated vehicle position or the second estimated vehicle position is inaccurate.

The method may further include performing one of: based on a determination that the first estimated vehicle position is inaccurate, initializing the first estimated vehicle position with the second estimated vehicle position; or based on a determination that the second estimated vehicle position is inaccurate, initializing the second estimated vehicle position with the first estimated vehicle position.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram illustrating constituent components of a vehicle according to an embodiment;

FIG. 2 and FIG. 3 illustrate an image of a camera and a distance relationship to a front object when a vehicle position is upward as the vehicle passes an obstacle such as a bump according to an embodiment;

FIG. 4 and FIG. 5 illustrate an image of a camera and a distance relationship to a front object when a vehicle position is downward as the vehicle passes an obstacle such as a bump according to an embodiment; and

FIG. 6 is a flowchart illustrating a method of estimating a distance according to a change in vehicle position according to an embodiment.

### DETAILED DESCRIPTION

Like reference numerals throughout the specification denote like elements. Also, this specification does not describe all the elements according to embodiments of the disclosure, and descriptions well-known in the art to which the disclosure pertains or overlapped portions are omitted.

It will be understood that when an element is referred to as being “connected” to another element, it can be directly or indirectly connected to the other element, wherein the indirect connection includes “connection” via a wireless communication network.

It will be understood that the term “include” when used in this specification, specifies the presence of stated features, integers, steps, operations, elements, and/or components, but does not preclude the presence or addition of at least one other features, integers, steps, operations, elements, components, and/or groups thereof.

It is to be understood that the singular forms are intended to include the plural forms as well, unless the context clearly dictates otherwise.

The terms such as “˜part”, “˜device”, “˜block”, “˜member”, “˜module”, and the like may refer to a unit for processing at least one function or act. For example, the terms may refer to at least a process processed by at least one hardware, such as field-programmable gate array (FPGA)/application specific integrated circuit (ASIC), software stored in memories or processors, or a combination of hardware and software.

Reference numerals used for method steps are just used for convenience of explanation, but not to limit an order of the steps. Thus, unless the context clearly dictates otherwise, the written order may be practiced otherwise.

In this instance, when the vehicle position is facing upward due to an obstacle, an angle of a camera capturing an image may be lowered in relation to the vehicle, and when the vehicle position is facing downward due to an obstacle, the camera angle may be raised. As a result, objects in the image may appear closer or farther away than they actually are.

Specifically, when an obstacle such as a bump causes the vehicle position to change momentarily and a position of an object in the image to change, a distance estimation error or inaccuracy may occur and a distance is recognized as closer than the actual distance.

As such, when a distance is estimated inaccurately due to a change in vehicle position, a vehicle may recognize the distance to a preceding vehicle (object) to be closer than the actual distance and stop suddenly, or recognize the distance to be farther than the actual distance and accelerate.

Accordingly, when a position of a vehicle passing through an obstacle changes, inaccurate distance information obtained from an image is required to be corrected.

Hereinafter, embodiments of the disclosure will be described in detail with reference to the accompanying drawings.

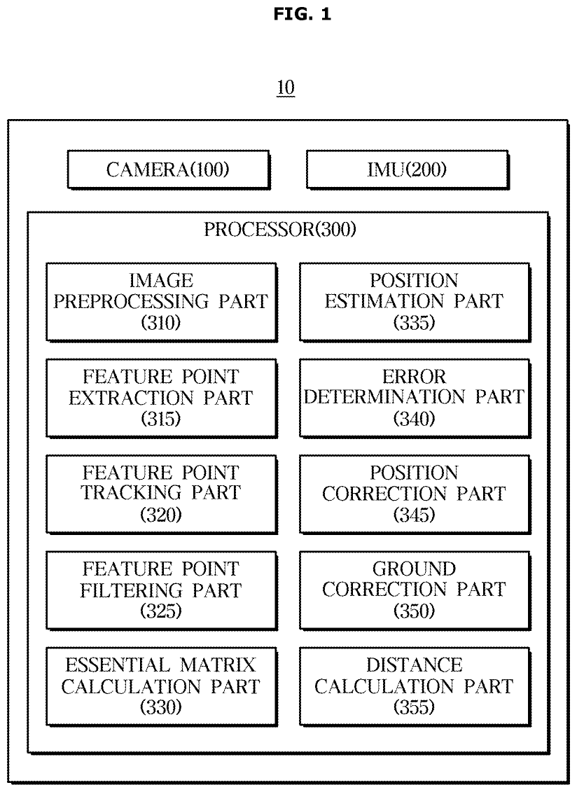

FIG. 1 is a block diagram illustrating constituent components of a vehicle according to an embodiment.

Referring to FIG. 1, a vehicle 10 according to an embodiment includes a camera 100, an inertial measurement unit (IMU, 200), and a processor 300 which estimates a vehicle position of the vehicle 10 based on an image obtained from the camera 100 and adjusts (e.g., corrects) the estimated vehicle position using a vehicle position estimated based on a measurement of the IMU 200.

Each of the components (e.g., parts) of the processor 300 as illustrated in FIG. 1 may be implemented with hardware, software, or a combination of both. For example, the components 310 to 355 may be implemented as instructions that, when executed by the processor 300, cause the processor 300 to perform corresponding functions and/or actions as described herein. The instructions may be stored in computer-readable storage such as memory.

Here, the processor 300 may include an image preprocessing part 310 removing noise (e.g., image noise) from the image obtained from the camera 100, and designating a region of interest in the image.

Also, the processor 300 may include a feature point extraction part 315 extracting a feature point in the region of interest.

The processor 300 may also include a feature point tracking part 320 tracking a change in position of the feature point for each frame of the image, and performing matching between the feature points corresponding to each other of a previous frame and a current frame.

The processor 300 may also include a feature point filtering part 325 removing mismatched feature point pairs from the matched feature point pairs.

The processor 300 may also include an essential matrix calculation part 330 estimating an essential matrix using a geometric relationship between the matched feature point pairs in a normalized image plane.

The processor 300 may also include a position estimation part 335 estimating a rotation matrix and a transformation matrix from the essential matrix, and estimating a vehicle position of the vehicle 10 based on the rotation matrix and the transformation matrix.

Here, the position estimation part 335 estimates the vehicle position of the vehicle 10 facing up or down by estimating a pitch value from the rotation matrix.

The processor 300 may also include an error determination part 340 comparing an average value of an absolute error (e.g., disparity, difference) between the vehicle position estimated based on the measurement of the IMU and the vehicle position estimated based on the image obtained from the camera with a set threshold value, and determining whether an inaccurate position is being estimated due to error accumulation.

The processor 300 may also include a position correction part 345. When the error determination part 340 determines that an inaccurate position is being estimated, the position correction part 345 estimates a difference in vehicle positions in a current frame and a previous frame separated from the current frame by a set interval (e.g., time interval) based on two sensors, i.e., the camera and the IMU, respectively, and determines that a sensor with a larger difference estimates a vehicle position with the error accumulation.

Here, when the sensor with the larger difference is the IMU 200, the position correction part 345 may initialize (e.g., calibrate, adjust, replace) the vehicle position estimated based on the measurement of the IMU 200 with the vehicle position estimated based on the image obtained from the camera 100. In addition, when the sensor with the larger difference is the camera 100, the position correction part 345 may initialize (e.g., calibrate, adjust, replace) the vehicle position estimated based on the image obtained from the camera 100 with the vehicle position estimated based on the measurement of the IMU 200.

The processor 300 may also include a ground correction part 350. When it is determined that a change in vehicle position of the vehicle 10 occurs based on the adjusted (e.g., corrected) vehicle position, the ground correction part 350 may adjusts (e.g., correct) a point of a three-dimensional (3D) coordinate system of an actual ground area according to the change in vehicle position of the vehicle 10, obtain a point of a camera coordinate system corresponding to the corrected point of the actual ground area, and then estimate the 3D coordinate system of the actual ground area from a two-dimensional (2D) coordinate system of a ground area in the image by a perspective transform matrix.

The processor 300 may also include a distance calculation part 355 estimating a distance to an actual object corresponding to a position of an object in the image using the estimated 3D coordinate system of the actual ground area.

Hereinafter, the above-described constituent components of the vehicle 10 are described in detail.

The camera 100 may be a front camera fixed to the vehicle 10 to capture a scene in front of the vehicle 10. The camera 100 may obtain an image through a frame grabber and transmit the image to another device via Ethernet network.

The image preprocessing part 310 performs an image smoothing process such as removing noise (e.g., image noise) from the image obtained from the camera 100, and designates a region of interest (ROI) in the image. The region of interest refers to a selected region within the image for image analysis. The image preprocessing part 310 may remove noise from the image, for example, using a bilateral filter.

The feature point extraction part 315 extracts a feature point from the above-described ROI, for example, using a Features from Accelerated Segment Test (FAST) algorithm. For instance, the feature point extraction part 315 may extract edges or corners from the ROI as a feature point.

The feature point tracking part 320 may track a feature point, for example, using a pyramidal Lucas-Kanade which is an optical flow-based algorithm. The feature point tracking part 320 tracks a change in position of the feature point for each frame of the image, and performs matching between the feature points corresponding to each other of a previous frame and a current frame.

The feature point filtering part 325 may remove mismatched feature point pairs from the matched feature point pairs, and performs filtering to separate properly matched feature point pairs. For example, the feature point filtering part 325 may repeatedly remove erroneously matched feature points (outliers) through a Random Sample Consensus (RANSAC) algorithm. In this instance, an average motion vector size among feature point pairs may be estimated to remove abnormal feature point pairs.

The essential matrix calculation part 330 estimates an essential matrix based on a relationship between the matched feature point pairs. Also, the essential matrix calculation part 330 may estimate a rotation matrix and a transformation matrix from the essential matrix through a singular value decomposition (SVD). The essential matrix represents a geometric relationship between the matched feature point pairs in a normalized image plane.

The essential matrix calculation part 330 may use epipolar geometry principles when estimating a relationship between images.

The essential matrix calculation part 330 may estimate the essential matrix by randomly extracting, for example, five feature point pairs from the matched feature point pairs corresponding to each other by RANSAC which is an iterative algorithm. Also, the essential matrix calculation part 330 confirms whether other feature points are properly matched feature points through the essential matrix by using RANSAC. When the set number of iterations is reached, the essential matrix calculation part 330 may estimate an essential matrix in which the number of feature points is maximized.

The position estimation part 335 estimates a vehicle position of the vehicle 10 based on the rotation matrix and the transformation matrix estimated from the essential matrix. In this instance, the position estimation part 335 may estimate the vehicle position of the vehicle 10 using a pitch value which is most affected by the change in vehicle position.

That is, the position estimation part 335 may estimate the pitch value from the rotation matrix estimated from the essential matrix, thereby estimating the vehicle position of the vehicle 10. The vehicle 10 mostly travels in a straight line, and when the vehicle 10 passes over an obstacle such as a bump, the amount of pitch change may be used to estimate the position change amount of the vehicle 10. On the contrary, roll and yaw do not significantly affect a change in vehicle position.

Meanwhile, the IMU 200 may include an accelerometer, a gyroscope, and a magnetometer. The accelerometer measures acceleration in x-axis, y-axis, and z-axis directions, the gyroscope measures an angular velocity, and the magnetometer measures terrestrial magnetism. Data obtained from the IMU 200 includes information about orientation, angular velocity, and linear acceleration. Based on values of each sensor included in the IMU 200, pitch (Y), roll (X), and yaw (Z) angles may be estimated, and a rotation matrix may be expressed through the above. A vehicle position of the vehicle 10 may be estimated from the rotation matrix.

The processor 300 may initialize (e.g., calibrate, adjust, replace) an initial position of the vehicle 10 based on a measurement of the IMU 200, i.e., a sensor value measured by the IMU 200. When the vehicle 10 is stopped, no change occurs in images of camera, and thus a vehicle position of the vehicle 10 may not be estimated based on the image. Accordingly, the vehicle position of the vehicle 10 may be estimated based on the measurement of the IMU 200. That is, when an average of movement amounts of motion vectors is within a predetermined range, it may be determined that the vehicle 10 is not moving, and in this case, the vehicle position of the vehicle 10 may be estimated using the measurement of the IMU 200.

The error determination part 340 estimates an average value of an absolute error between the vehicle position estimated based on the measurement of the IMU 200 and the vehicle position estimated based on the image obtained from the camera 100 by Equation 1 below, and compares the average value of the absolute error with a set threshold value, thereby determining whether an inaccurate position is being estimated due to error accumulation.

$$error = \frac{1}{5} {\sum }_{i = 1}^{5} ( \vert {imu}_{i} - {cam}_{i} \vert ) \qquad [ Equation 1 ]$$

In Equation 1 above, for example, from a current frame at a point in time t to a previous frame at a point in time t-5, a vehicle position of the vehicle 10 is estimated based on the camera 100 and the IMU 200, respectively, and an average value of an absolute error between a vehicle position imuᵢ of the vehicle 10 estimated based on the IMU 200 and a vehicle position camᵢ of the vehicle 10 estimated based on the camera 100 is estimated.

Here, when the average value of the absolute error is greater than the set threshold value, the error determination part 340 may determine that the vehicle position estimated based on either of the two sensors, the camera 100 and the IMU 200, is inaccurate.

In contrast, when the average value of the absolute error is less than the set threshold value, the error determination part 340 may use the vehicle position estimated based on the camera 100.

In this instance, a pitch value may be used for position estimation, as described above. That is, the amount of pitch change may be estimated for each frame based on the camera 100 and the IMU 200, respectively, and the average value of the absolute error between the vehicle position imuᵢ estimated based on the IMU 200 and the vehicle position camᵢ estimated based on the camera 100 may be estimated by substituting the amount of pitch change into Equation 1. For example, when the average value of the absolute error is greater than a threshold value 3 [degree], it may be determined that the vehicle position estimated based on either of the two sensors, the camera 100 and the IMU 200, is inaccurate.

When the error determination part 340 determines that the inaccurate position is being estimated, the position correction part 345 estimates a difference in vehicle positions in a current frame and a previous frame separated from the current frame by a set interval (e.g., time interval) based on the two sensors of the camera 100 and the IMU 200, respectively, and determines that a sensor with a larger difference estimates a vehicle position including the error accumulation.

For example, the position correction part 345 estimates a difference between a vehicle position of a frame at the point in time t-5 and a vehicle position of a frame at the point in time t based on the camera 100 and the IMU 200, respectively, and determines that a sensor with a larger difference estimates a vehicle position including the error accumulation.

In addition, the position correction part 345 determines that a sensor with a smaller difference between the two sensors is less affected by external influences or has less accumulated error, and recognizes a value from the sensor with the smaller difference as a reliable value. Here, the frame at the point in time t-5 is a frame that is a set interval away from the current frame t. In other examples, however, the set interval may change.

When it is determined that the vehicle position estimated based on the camera 100 includes error accumulation, the position correction part 345 determines the vehicle position estimated based on the IMU 200 as an adjusted (e.g., corrected) vehicle position. In this instance, the position correction part 345 may initialize (e.g., calibrate, adjust, replace) the vehicle position estimated based on the camera 100 with the vehicle position estimated based on the IMU 200.

In addition, when it is determined that the vehicle position estimated based on the IMU 200 includes error accumulation, the position correction part 345 determines the vehicle position estimated based on the camera 100 as an adjusted (e.g., corrected) vehicle position. In this instance, the position correction part 345 may initialize (e.g., calibrate, adjust, replace) the vehicle position estimated based on the IMU 200 with the vehicle position estimated based on the camera 100.

When it is determined that a change in vehicle position of the vehicle 10 has occurred based on the vehicle position determined by the position correction part 345, the ground correction part 350 adjusts (e.g., corrects) a point of a 3D coordinate system of an actual ground area according to the change in vehicle position of the vehicle 10, obtains a point of a camera coordinate system corresponding to the corrected point of the actual ground area, and then estimates the 3D coordinate system of the actual ground area from a 2D coordinate system of a ground area in the image by a perspective transform matrix.

That is, when no change in vehicle position has occurred, it is recognized as a flat ground, and a distance is estimated based on an initial ground area. However, when a position of the vehicle 10 changes, a new corrected ground area is obtained by the ground correction part 350, and a distance to an object is estimated based on the corrected ground area.

After the vehicle position is estimated and/or adjusted, the vehicle may adjust its operation (e.g., acceleration, steering, braking, etc.) based on the estimated vehicle position.

To help understanding, an initial ground area estimation and a distance estimation to an object are described first, and then in an event of position change of the vehicle 10 according to an embodiment, a ground area correction and a distance estimation to an object based on the corrected ground area are described.

To estimate the initial actual ground area, a light detection and ranging (lidar, not shown) mounted on the vehicle 10 obtains 3D point (X, Y, Z) data of several points on a flat ground without a slope.

Afterwards, modeling the obtained actual ground data into a 3D plane equation ax+by +cz+d=0 is performed through RANSAC.

Next, an extent of the ground area is set to four points {(x₀^{real}, y₀^{real}), . . . , (x₃^{real}, y₃^{real})}. In this instance, units are set to meters. Also, setting the extent of the ground area as the four points is only an example, and may vary in other examples. The actual ground area may be set to a rectangular shape, and the four points may correspond to each corner of the rectangular ground area.

By using the modeled plane equation, (zₗ^{real}) may be estimated through each point (xᵢ^{real}, yᵢ^{real}) on the determined actual ground area.

Here, when the ground is not perfectly flat, ground correction may be performed by applying a slope confirmed by a leveling instrument (not shown) to an initial ground.

Once the estimation of the initial actual ground area is complete, the distance estimation to the object is performed.

Specifically, a relationship among the four points {(x₀^{real}, y₀^{real}, z₀^{real}), . . . , (x₃^{real}, y₃^{real}, z₃^{real})} of an XY coordinate system of the actual ground area estimated in the above-described ground area estimation process and four points {(u₀^{img}, v₀^{img}), . . . , (u₃^{img}, v₃^{img})} corresponding thereto of the camera coordinate system of the camera 100 is estimated using a perspective transform matrix. Afterwards, coordinates (u^{img}, v^{img}) of a lower center of a 2D bounding box of a detected object are estimated as homogeneous coordinates again to convert into a (u^{img}, v^{img}, 1) form.

Also, 3D coordinates (x^{real}, y^{real}, w) of a real environment are estimated from the 2D coordinates (u^{img}, v^{img}, 1) in the image of the camera 100 through an operation with the perspective transform matrix described above.

Next, by applying the estimated 3D coordinate value to Equation 2 below, a distance to an actual object corresponding to a position of the object in the image of the camera 100 is estimated using the Euclidean distance formula.

$$distance = \sqrt{{x}^{{reαl}^{2}} + {y}^{{real}^{2}}} \qquad [ Equation 2 ]$$

Based on the above-described initial ground area estimation and distance estimation to an object, ground area correction and distance estimation based on the corrected ground area may be performed in an event of position change of the vehicle 10 according to an embodiment.

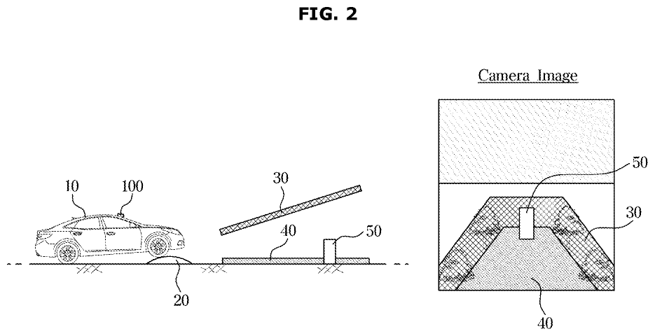

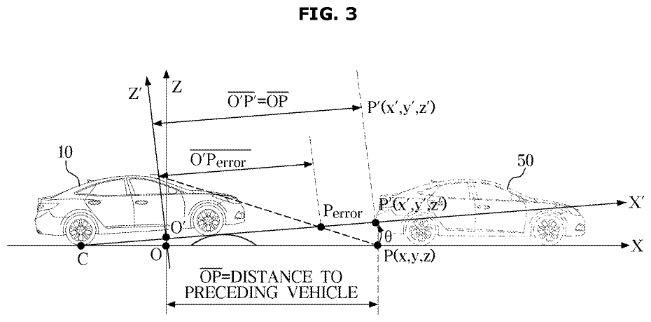

FIG. 2 and FIG. 3 illustrate an image of a camera and a distance relationship to a front object when a vehicle position is upward as the vehicle passes an obstacle such as a bump according to an embodiment.

Referring to FIG. 2 and FIG. 3, when a position of the vehicle 10 is upward as the vehicle 10 passes an obstacle such as a bump 20, an image of the camera 100 is lowered as a whole, and a position of an object 50 on the ground area is changed, causing an error in which a recognized distance result becomes closer. In order to reduce such errors, an initial ground area 30 is required to be dynamically changed to a ground area 40 corrected from a position change of the vehicle 10.

Here, a pitch value significantly affects a distance estimation result due to the position change of the vehicle 10, and a roll value has a relatively small effect thereon. Because a yaw value has little effect, the yaw value may be excluded when estimating a distance estimation result due to the position change of the vehicle 10. According to an embodiment, the pitch value may be used when estimating a position of the vehicle 10.

Specifically, as shown in FIG. 3, due to the vehicle 10 passing an obstacle such as the bump 20, when a position of the vehicle 10 is upward and pitchθ>0, a position of Perror, not a position P of the vehicle 10, is detected. Accordingly, a distance O̅′̅P̅e̅r̅r̅o̅r̅ shorter than a distance O̅P̅ may be detected, and thus an error occurs in which a result of recognizing the distance to the object 50 is closer than an actual distance. Therefore, O̅′̅P̅′̅, which is a distance to P′ obtained by rotating P about C, is required to be estimated.

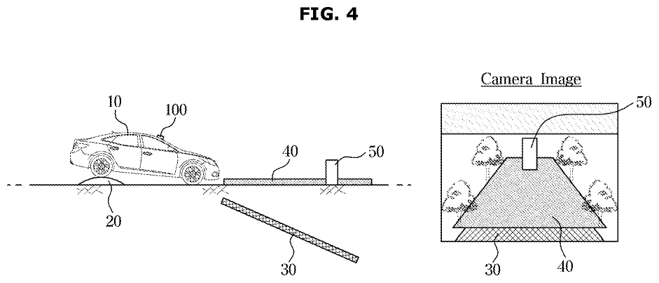

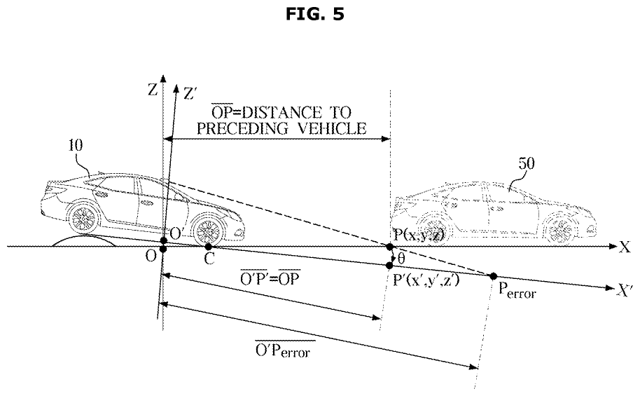

FIG. 4 and FIG. 5 illustrate an image of a camera and a distance relationship to a front object when a vehicle position is downward as the vehicle passes an obstacle such as a bump according to an embodiment.

Referring to FIG. 4 and FIG. 5, when a position of the vehicle 10 is downward as the vehicle 10 passes an obstacle such as a bump 20, an image of the camera 100 is raised as a whole, causing an error in which a recognized distance result becomes farther. In order to reduce such errors, an initial ground area 30 is required to be dynamically changed to a ground area 40 corrected from a position change of the vehicle 10.

Specifically, as shown in FIG. 5, due to the vehicle 10 passing an obstacle such as the bump 20, when a position of the vehicle 10 is downward and pitchθ<0, an error occurs in which a result of recognizing a distance to an object 50 is farther than an actual distance. Accordingly, O̅′̅P̅′̅, which is a distance to P′, is required to be estimated.

A vehicle position estimation result of the vehicle 10 according to an embodiment consists of a rotation matrix and a transformation matrix, and the rotation matrix may be estimated by estimating the three axes of yaw, pitch, and roll as shown in Equation 3 below.

$${R}_{z y x} = {R}_{z} ( yaw ) * {R}_{y} ( pitch ) * {R}_{x} ( roll ) \qquad [ Equation 3 ]$$

By performing an operation between the estimated rotation matrix R_{zyx} and the above-described initial ground area xᵢ^{real}, yᵢ^{real}, zᵢ^{real} obtained in advance, points in the 3D coordinate system of the actual ground area corrected by the changed position of the vehicle 10 may be obtained, which is expressed in Equation 4 below.

$$[ \begin{matrix}{x}_{i}^{new} \\ {y}_{i}^{new} \\ {z}_{i}^{new}\end{matrix} ] = {R}_{zyx} * [ \begin{matrix}{x}_{i}^{real} \\ {y}_{i}^{real} \\ {z}_{i}^{real}\end{matrix} ] \qquad [ Equation 4 ]$$

After obtaining four points in the camera coordinate system corresponding to the corrected four points {(x₀^{new}, y₀^{new}, z₀^{new}), . . . , (x₃^{new}, y₃^{new}, z₃^{new})} of the actual ground area, points in a 3D XY coordinate system of the actual ground area may be estimated from points in a 2D coordinate system of ground area in the image of the camera 100 by perspective transform matrix.

The distance calculation part 355 may estimate a distance to an actual object corresponding to a position of an object in the image by using the 3D XY coordinate system of the actual ground area estimated as above. In this instance, 20 bounding box information detected by a deep learning detector (not shown) may be used to estimate the distance to the actual object corresponding to the position of the object in the image.

When a multi-view camera is applied to an embodiment of the disclosure, for example, the distance to the actual object may be estimated by obtaining internal parameters K for left and right cameras, respectively, obtaining a relationship (R|t) of a rotation matrix and a transformation matrix with the left and right cameras based on the front camera 100, and then applying Kᵢ*Rᵢ|tᵢ to the corrected ground area, according to the processes described above.

The above-described constituent components of the vehicle 10 shown in FIG. 1 and means related thereto may be controlled by a controller (not shown). The controller may include the processor 300 and a memory (not shown). The memory may store programs, instructions, applications, etc., for control. The processor 300 may execute the programs, the instructions, the applications, etc., stored in the memory. For example, the controller may include control units such as an electronic control unit (ECU), micro controller unit (MCU), and the like.

The memory may include, for example, a volatile memory such as a random access memory (RAM), a non-volatile memory such as a cache, a flash memory, a read only memory (ROM), a programmable read only memory (PROM), an erasable programmable read only memory (EPROM), an electrically erasable programmable read only memory (EEPROM), etc., or a recording media such as a hard disk drive (HDD), or a compact disc read only memory (CD-ROM), without being limited thereto. The memory may store various algorithms, set values, data values, estimated values, positions, and the like, required for distance calculation according to the vehicle's position change.

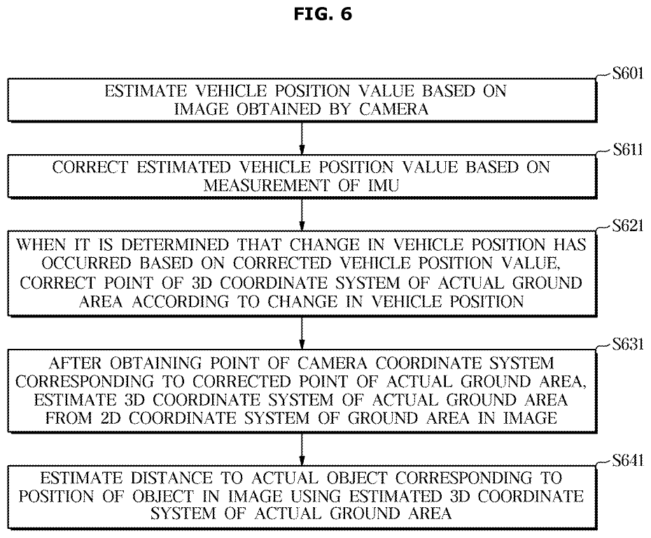

FIG. 6 is a flowchart illustrating a method of estimating a distance according to a change in vehicle position according to an embodiment.

For distance calculation according to a change in vehicle position, a vehicle position of the vehicle 10 is estimated based on an image obtained from the camera 100 (S601).

In operation S601, noise may be removed from the image obtained from the camera 100, a region of interest may be designated in the image, a feature point may be extracted from the region of interest, a change in position of the feature point may be tracked for each frame of the image, matching between the feature points corresponding to each other of a previous frame and a current frame may be performed, and filtering may be performed to remove mismatched feature point pairs from the matched feature point pairs.

Also, subsequent to the matching process, an essential matrix may be estimated using a geometric relationship between the matched feature point pairs in a normalized image plane, a rotation matrix and a transformation matrix may be estimated from the essential matrix, and a vehicle position of the vehicle 10 may be estimated based on the rotation matrix and the transformation matrix. Here, the vehicle position of the vehicle 10 facing up or down may be estimated by estimating a pitch value from the rotation matrix.

Next, the estimated vehicle position of the vehicle 10 is corrected using a vehicle position of the vehicle 10 estimated based on a measurement of the IMU 200 (S611).

In operation S611, an average value of an absolute error between the vehicle position estimated based on the measurement of the IMU 200 and the vehicle position estimated based on the image obtained from the camera 100 may be compared with a set threshold value, and whether an inaccurate position is being estimated due to error accumulation is determined.

In addition, when it is determined that an inaccurate position is being estimated due to error accumulation, a difference in vehicle positions in a current frame and a previous frame separated from the current frame by a set interval may be estimated based on two sensors which are the camera 100 and the IMU 200, respectively, and it may be determined that a sensor with a larger difference estimates a vehicle position including the error accumulation.

Here, when the sensor with a larger difference is the IMU 200, the vehicle position estimated based on the measurement of the IMU 200 may be initialized with the vehicle position estimated based on the image obtained from the camera 100, and when the sensor with a larger difference is the camera 100, the vehicle position estimated based on the image obtained from the camera 100 may be initialized with the vehicle position estimated based on the measurement of the IMU 200.

When it is determined that a change in position of the vehicle 10 has occurred based on the corrected vehicle position, a point of a 3D coordinate system of an actual ground area is corrected according to the change in position of the vehicle 10 (S621).

Next, after obtaining a point of a camera coordinate system corresponding to the corrected point of the 3D coordinate system of the actual ground area, the 3D coordinate system of the actual ground area is estimated from a 2D coordinate system of a ground area in the image (S631).

Afterwards, a distance to an actual object corresponding to a position of an object in the image is estimated using the estimated 3D coordinate system of the actual ground area (S641).

As is apparent from the above, according to the embodiments of the disclosure, the vehicle and the method of estimating a distance according to a change in vehicle position can estimate a position of the vehicle in real time and correct inaccurate distance information obtained from an image due to the change in vehicle position.

The vehicle and the method of estimating a distance according to a change in vehicle position can also accurately estimate a position of the vehicle using vehicle positions of two sensors of a camera and an IMU.

Although embodiments have been described for illustrative purposes, those skilled in the art will appreciate that various modifications, additions and substitutions are possible, without departing from the scope and spirit of the disclosure. Therefore, embodiments have not been described for limiting purposes.

What is claimed is:

1. A vehicle comprising:
a camera mounted on the vehicle to obtain an image outside the vehicle;
an inertial measurement unit (IMU) device; and
a processor configured to:
estimate, based on the image obtained from the camera, a vehicle position of the vehicle to yield a first estimated vehicle position;
adjust, based on a measurement of the IMU device, the first estimated vehicle position to yield a second estimated vehicle position; and
cause, based on the at least one of the first estimated vehicle position or the second estimated vehicle position, the vehicle to adjust at least one of:
acceleration, steering, or braking.

2. The vehicle of claim 1, wherein the processor is further configured to:
remove image noise from the image obtained from the camera; and
designate a region of interest in the image.

3. The vehicle of claim 2, wherein the processor is further configured to extract, from the region of interest, a feature point.

4. The vehicle of claim 3, wherein the image comprises a previous frame and a current frame, and
wherein the processor is further configured to:
track a change in position of the feature point across the previous frame and the current frame; and
perform matching of the feature point between the previous frame and the current frame.

5. The vehicle of claim 3, wherein the image comprises a previous frame and a current frame, and
wherein the processor is further configured to:
track a change in position of the feature point across the previous frame and the current frame; and
based on a mismatch of the feature point between the previous frame and the current frame, remove the feature point.

6. The vehicle of claim 4, wherein the processor is further configured to estimate an essential matrix using a geometric relationship, in a normalized image plane, of the feature point between the previous frame and the current frame.

7. The vehicle of claim 6, wherein the processor is further configured to:
estimate, based on the essential matrix, a rotation matrix and a transformation matrix, and
wherein the processor is configured to estimate the vehicle position of the vehicle by estimating the vehicle position further based on the rotation matrix and the transformation matrix.

8. The vehicle of claim 7, wherein the processor is further configured to estimate the vehicle position of the vehicle as facing up or down by estimating a pitch value based on the rotation matrix.

9. The vehicle of claim 1, wherein the processor is further configured to:
compare, based on a threshold value, an average value of a difference between the first estimated vehicle position and the second estimated vehicle position; and
determine, based on the comparison, whether at least one of the first estimated vehicle position or the second estimated vehicle position is inaccurate.

10. The vehicle of claim 9, wherein the image comprises a previous frame and a current frame that are separated by a time interval, and
wherein the processor is further configured to:
determine:
a first vehicle position difference, between the current frame and the previous frame, as measured by the camera, and
a second vehicle position difference, between the current frame and the previous frame, as measured by the IMU device; and
based on a comparison between the first vehicle position difference and the second vehicle position difference, determine that one of the first estimated vehicle position or the second estimated vehicle position is inaccurate.

11. The vehicle of claim 10, wherein the processor is further configured to:
based on a determination that the first estimated vehicle position is inaccurate, initialize the first estimated vehicle position with the second estimated vehicle position; and
based on a determination that the second estimated vehicle position is inaccurate, initialize the second estimated vehicle position with the first estimated vehicle position.

12. The vehicle of claim 1, wherein the processor is further configured to:
adjust a point of a three-dimensional (3D) coordinate system of an actual ground area according to a difference between the first estimated vehicle position and the second estimated vehicle position;
obtain a point of a camera coordinate system corresponding to the adjusted point of the 3D coordinate system of the actual ground area; and
estimate, based on a two-dimensional (2D) coordinate system of a ground area in the image, the 3D coordinate system of the actual ground area by a perspective transform matrix.

13. The vehicle of claim 12, wherein the processor is further configured to estimate, based on the estimated 3D coordinate system of the actual ground area, a distance to an actual object that corresponds to a position of an object in the image.

14. A method comprising:
estimating, based on an image obtained via a camera, a position of a vehicle to yield a first estimated vehicle position;
adjusting, based on a measurement by an inertial measurement unit (IMU) device, the first estimated vehicle position to yield a second estimated vehicle position;
based on a determination that the first estimated vehicle position is different from the second estimated vehicle position, adjusting a point of a three-dimensional (3D) coordinate system of an actual ground area according to a difference between the first estimated vehicle position and the second estimated vehicle position;
obtaining a point of a camera coordinate system corresponding to the adjusted point of the 3D coordinate system of the actual ground area;
estimating, based on a two-dimensional (2D) coordinate system of a ground area in the image, the 3D coordinate system of the actual ground area;
estimating, based on the estimated 3D coordinate system of the actual ground area, a distance to an actual object that corresponds to a position of an object in the image; and
causing, based on the at least one of the first estimated vehicle position or the second estimated vehicle position, the vehicle to adjust at least one of: acceleration, steering, or braking.

15. The method of claim 14, wherein the image comprises a previous frame and a current frame, and
wherein the estimating of the position of the vehicle based on the image obtained via the camera comprises:
removing image noise from the image;
designating a region of interest in the image;
extracting, from the region of interest, a feature point;
tracking a change in position of the feature point across the previous frame and the current frame; and
performing matching of the feature point between the previous frame and the current frame.

16. The method of claim 15, further comprising:
filtering to remove a mismatched feature point that does not match between the previous frame and the current frame.

17. The method of claim 15, further comprising:
estimating an essential matrix using a geometric relationship, in a normalized image plane, of the feature point between the previous frame and the current frame; and
estimating, based on the essential matrix, a rotation matrix and a transformation matrix,
wherein the estimating the position of the vehicle comprises estimating the position of the vehicle further based on the rotation matrix and the transformation matrix.

18. The method of claim 17, wherein the estimating of the position of the vehicle comprises estimating the position of the vehicle as facing up or down by estimating a pitch value based on the rotation matrix.

19. The method of claim 14, wherein the adjusting of the first estimated vehicle position comprises:
comparing, based on a threshold value, an average value of a difference between the first estimated vehicle position and the second estimated vehicle position; and
determining, based on the comparison, whether at least one of the first estimated vehicle position or the second estimated vehicle position is inaccurate.

20. The method of claim 19, wherein the image comprises a previous frame and a current frame that are separated by a time interval, and
wherein the method further comprises:
determining:
a first vehicle position difference, between the current frame and the previous frame, as measured by the camera, and
a second vehicle position difference, between the current frame and the previous frame, as measured by the IMU device; and
based on a comparison between the first vehicle position difference and the second vehicle position difference, determining that one of the first estimated vehicle position or the second estimated vehicle position is inaccurate.

21. The method of claim 20, further comprising performing one of:
based on a determination that the first estimated vehicle position is inaccurate, initializing the first estimated vehicle position with the second estimated vehicle position; or
based on a determination that the second estimated vehicle position is inaccurate, initializing the second estimated vehicle position with the first estimated vehicle position.
